(19) United States
(12) Patent Application Publication
(10) Pub. No.: US 2007/0228667 A1
(43) Pub. Date: Oct. 4, 2007

(54) Apparatus for preventing seal extrusion

(75) Inventor: Daniel F. Zivi, Severna Park, MD (US)

Correspondence Address: ROTHWELL, FIGG, ERNST & MANBECK, P.C., 1425 K STREET, N.W., SUITE 800, WASHINGTON, DC, 20005, US

(73) Assignee: Northrop Grumman Corporation, Los Angeles, CA (US)

(21) Appl. No.: 11/395,250

(22) Filed: Apr. 3, 2006

(51) Int. Cl. F16L 17/06

(52) U.S. Cl. 277/611

(57) ABSTRACT

Embodiments of the present invention provide an apparatus for preventing seal extrusion.

### BACKGROUND OF THE INVENTION

1. Field of the Invention

The present invention relates generally to seals.

2. Discussion of the Background

A need exists for an apparatus than can prevent seal extrusion.

### SUMMARY OF THE INVENTION

The present invention provides various embodiments for preventing seal extrusion.

An apparatus according to one embodiment of the invention includes: a rigid body having a groove formed in a surface thereof; an elastomeric seal disposed in the groove, wherein the height of the seal is greater than the depth of the groove so that a top portion of the seal extends above the surface of the body; and a generally L shaped backup plate having a top portion and a side portion, the top portion resting on a top surface of the seal and the side portion being disposed between a wall of the groove and a side of the seal. The backup plate is configured to prevent seal extrusion. The seal may be a linear seal. Preferably, the backup plate is not attached to the body. Also, the height of the side portion of the backup plate may be less than the height of the seal when the seal is uncompressed, thereby enabling the backup plate to move towards the bottom of the groove when the seal is compressed.

An apparatus according to one embodiment of the invention includes: a first rigid body having a groove formed in a surface thereof; a crush style seal disposed in the groove, wherein the height of the seal when the seal is uncompressed is greater than the depth of the groove; a right angle backup plate having a first member and a second member, wherein the first and second members form a generally right angle, the first member covering a portion of the top surface of the seal and the second member being disposed between a wall of the groove and a side of the seal; a second rigid body, wherein the first and second rigid bodies are clamped together such that a surface of the second rigid body contacts the top surface of the seal; and a gap formed between the surface of the first rigid body and the surface of the second rigid body, wherein the backup plate is configured to prevent the seal from extruding into the gap.

A method according to one embodiment of the invention includes: obtaining a rigid body having a groove formed in a surface thereof; placing an elastomeric seal in the groove, wherein the height of the seal is greater than the depth of the groove so that a top portion of the seal extends above the surface of the body; and positioning a generally right angle backup plate having a first member and a second member so that the first member rests on a top surface of the seal and the second member is disposed between a wall of the groove and a side of the seal, wherein the first and second members form a generally right angle.

The above and other features of embodiments of the present invention are described below with reference to the accompanying drawings.

### BRIEF DESCRIPTION OF THE DRAWINGS

The accompanying drawings, which are incorporated herein and form part of the specification, help illustrate various embodiments of the present invention. In the drawings, like reference numbers indicate identical or functionally similar elements.

FIGS. 1-2 illustrate a cross-section view of an apparatus according to one embodiment of the present invention.

FIGS. 3-4 illustrate a cross-section view of an apparatus according to another embodiment of the present invention.

FIGS. 5-6 illustrate a cross-section view of an apparatus according to another embodiment of the present invention.

### DETAILED DESCRIPTION OF PREFERRED EMBODIMENTS

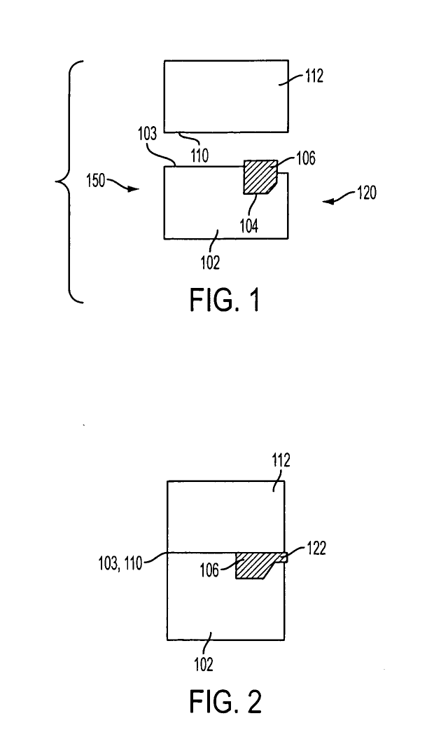

FIG. 1 illustrates a cross-section view of an apparatus according to one embodiment of the present invention. More specifically, FIG. 1 shows a cross-sectional view of rigid body 102 having a groove 104 formed in a surface 103 thereof. Groove 104 may be linear and extend the entire length of the body 102. Disposed in the groove 104 is a seal 106 (e.g., an elastomeric linear seal). As shown, seal 106 and groove 104 may have a generally rectangular cross-section and the height of seal 106 may be greater than the depth of groove 104 so that a top portion of seal 106 extends above surface 103. The seal 106 may have one or two large bevels at the corners.

Preferably, seal 106 is a crush style seal, meaning that the groove is over filled with the seal (i.e., the depth of the groove is less than the height of the seal). As illustrated in FIG. 2, when surface 103 of body 102 is tightly mated to a surface 110 of a second body 112, the seal 106 is compressed and forced outward in the direction of a high pressure side 120 into a high-pressure side extrusion gap 122, which exists between sides 103 and 110 even when the sides are tightly mated.

As also shown in FIG. 2, in one embodiment (e.g., where the two mating surfaces 103 and 110 are clean and accurately dimensioned and sufficient clamping force is used to force the two sides together) the portion of side 103 that is between groove 104 and a low pressure side 150 is completely flush with side 110 so that there is substantially no low-pressure side gap into which seal 106 can extrude.

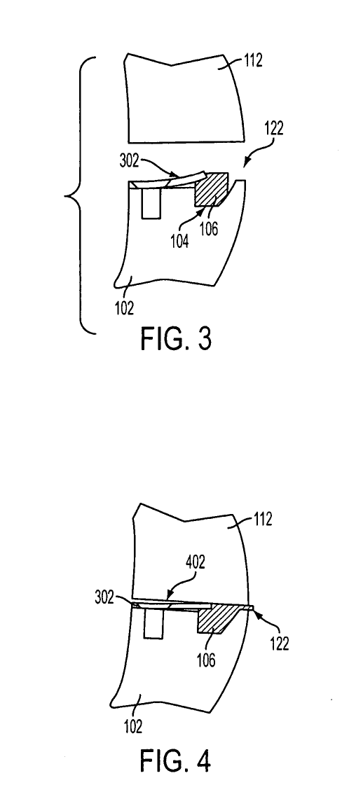

In some applications it may be impossible to prevent a low-pressure side gap from forming when surfaces 103 and 110 are forced together. In these application, a backup plate 302 (see FIG. 3) may be used to prevent seal 106 from extruding into a low-pressure side gap existing between surfaces 103 and 110.

Backup plate 302 can be effective at allowing a gap 402 to exist between surfaces 103 and 110 while at the same time preventing seal 106 from extruding into the gap, as is illustrated in FIG. 4. This configuration has proven to function very well even if the seal is contaminated with sand or other debris. However, backup plate 302 is typically attached to body 102 (e.g., screwed to body 102), requires significant time to install, and increases the width of the seal assembly. Accordingly, there exists a need for another method for preventing seal extrusion on the low-pressure side when a gap 402 between mating surfaces 103 and 110 or contamination exists, but would not require the added width and complexity of using a screwed down backup plate. Minimizing seal assembly width may be important in some applications where reliability requirements require the use of two seals side by side.

Improved Design

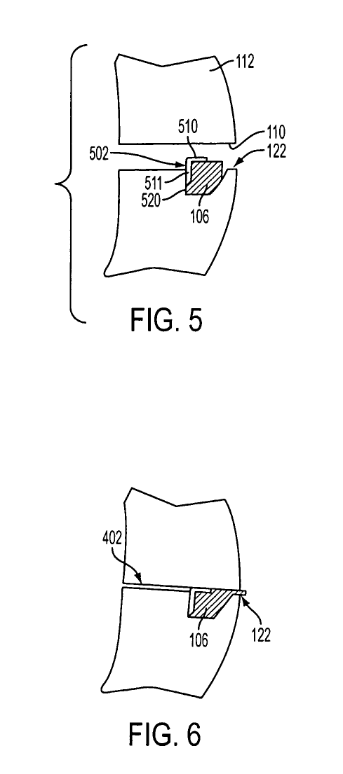

Referring now to FIG. 5, FIG. 5 illustrates the use of a substantially L shaped backup plate 502 having a top portion 510 and a side portion 511. Top portion 510 and side portion 511 form a generally right angle. Backup plate 502 may be made from brass or other metal or combination of metals.

By positioning backup plate 502 so that top portion 510 rests on the top surface of seal 106 and side portion 511 is disposed between the low-pressure side wall 520 of groove 104 and seal 106, backup plate 502 is effective in preventing seal 106 from extruding into gap 402 when bodies 102 and 112 are clamped together, as shown in FIG. 6. As illustrated in FIGS. 5 and 6, the height of side portion 511 may be less than the height of seal 106 when seal 106 is in an uncompressed state. This allows plate 502 to move together with seal 106 when seal 106 is compressed when surfaces 103 and 110 are clamped together.

One advantage of backup plate 502 is that it keeps the complete seal width to a minimum and is easy to install. Another advantage is that, because backup plate 502 may move up and down with seal 106, backup plate may prevent seal extrusion under the backup plate, as can occur when using backup plate 302.

The present invention can be used in many environments. For example, an undersea pressure vessel, or other pressure vessel, may incorporate one or more of the above described embodiments. Additionally, a water storage tank may incorporate one or more of the above described embodiments. The backup plate design illustrated in FIGS. 5 and 6 would be applicable to in applications where there may be less than perfect mating surfaces 103, 110 because plate 502 will ensure that seal extrusion does not occur.

While various embodiments/variations of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

What is claimed is:

1. An apparatus, comprising:
a rigid body having a groove formed in a surface thereof;
an elastomeric seal disposed in the groove, wherein the height of the seal is greater than the depth of the groove so that a top portion of the seal extends above the surface of the body; and
a generally L shaped backup plate having a top portion and a side portion, the top portion resting on a top surface of the seal and the side portion being disposed between a wall of the groove and a side of the seal.

2. The apparatus of claim 1, wherein the seal is a linear seal.

3. The apparatus of claim 1, wherein the backup plate is not attached to the body.

4. The apparatus of claim 1, wherein the height of the side portion of the backup plate is less than the height of the seal when the seal is uncompressed, thereby enabling the backup plate to move towards the bottom of the groove when the seal is compressed.

5. An apparatus, comprising:
a first rigid body having a groove formed in a surface thereof;
a crush style seal disposed in the groove, wherein the height of the seal when the seal is uncompressed is greater than the depth of the groove;
a right angle backup plate having a first member and a second member, wherein the first and second members form a generally right angle, the first member covering a portion of the top surface of the seal and the second member being disposed between a wall of the groove and a side of the seal;
a second rigid body, wherein the first and second rigid bodies are clamped together such that a surface of the second rigid body contacts the top surface of the seal; and
a gap formed between the surface of the first rigid body and the surface of the second rigid body, wherein
the backup plate is configured to prevent the seal from extruding into the gap.

6. The apparatus of claim 5, wherein the seal is an elastomeric seal.

7. The apparatus of claim 6, wherein the seal is a linear seal.

8. The apparatus of claim 5, wherein the backup plate is not attached to the first body.

9. The apparatus of claim 5, wherein the height of the second member of the backup plate is less than the height of the seal when the seal is uncompressed, thereby enabling the backup plate to move towards the bottom of the groove when the seal is compressed.

10. A method, comprising:
obtaining a rigid body having a groove formed in a surface thereof;
placing an elastomeric seal in the groove, wherein the height of the seal is greater than the depth of the groove so that a top portion of the seal extends above the surface of the body; and
positioning a generally right angle backup plate having a first member and a second member so that the first member rests on a top surface of the seal and the second member is disposed between a wall of the groove and a side of the seal, wherein the first and second members form a generally right angle.

11. The method of claim 10, further comprising obtaining a second rigid body and clamping the bodies together so that the seal compresses.

12. The method of claim 10, wherein the seal is an elastomeric seal.

13. The method of claim 12, wherein the seal is a linear seal.

14. The method of claim 10, wherein the backup plate is not attached to the body.

15. The method of claim 10, wherein the backup plate is made from brass or other metal.

16. The method of claim 10, wherein the height of the second member of the backup plate is less than the height of the seal when the seal is uncompressed, thereby enabling the backup plate to move towards the bottom of the groove when the seal is compressed.
